(19) United States
(12) Patent Application Publication
(10) Pub. No.: US 2018/0053259 A1
(43) Pub. Date: Feb. 22, 2018

(54) SYSTEM AND METHOD FOR PERSONALIZED, POLICY BASED EXPENSE PROCESSING

(71) Applicants: Kabushiki Kaisha Toshiba, Minato-ku (JP); Toshiba TEC Kabushiki Kaisha, Shinagawa-ku (JP)

(72) Inventor: Rashmi M. Brahma, Irvine, CA (US)

(21) Appl. No.: 15/241,382

(22) Filed: Aug. 19, 2016

(51) Int. Cl. G06Q 40/00; G06Q 20/14; G06Q 20/10

(52) U.S. Cl. CPC G06Q 40/12; G06Q 20/102; G06Q 20/145

(57) ABSTRACT

A system and method for purchase cost allocation, payment and reporting includes a device receiving charge data corresponding to a purchase of goods or services from a merchant by a user. The device also receives a merchant category classification code associated with the merchant and stores account data corresponding to at least one business charge account and at least one personal charge account. A processor categorizes received charge data as a business charge or a personal charge in accordance with a comparison of received charge data and the merchant category classification code. The device generates debit data for the business charge account or the personal charge account in accordance with categorized charge data. Charges may be further categorized in accordance with established company policies retrieved from a storage, from calendar data showing timing of business trips or from a location from where a purchase transaction occurs.

### TECHNICAL FIELD

This application relates generally to automated accounting and payment systems. The application more particularly relates to payment, tracking and fee allocation for business travelers.

### BACKGROUND

Payment for goods and services has evolved from barter, to cash, to checks, and more recently to credit cards and debit cards. Merchant transactions are typically undertaken at a point of sale, such as a shop in the case of goods, or in person in the case of services. Transactions are frequently followed with a receipt. Early receipts were hand written, perhaps in duplicate for the transacting parties such as with carbon paper. More recently, transactions involved mechanical devices that could process a transaction and generate a printed receipt. Payment by check also provided a receipt evidencing a transaction.

Point-of-sale devices evolved from mechanical adding machines and cash registers to computerized terminals. Devices evolved to become networked, allowing for immediate communication between merchants, credit agencies and banking institutions. While the term “credit card” and “debit card” are still used, many credit or debit transactions do not involve use of a physical card. They may be accomplished by exchange of financial information or by payment with a consumer device, such as via a smartphone. Receipts may still be printed on site during a transaction. Instead of, or in addition to printing of receipts, electronic versions may be sent, such as via e-mail.

Receipts are important for situations such as documenting a transaction for possible return of an item for a refund or exchange. Receipts may also provide evidence supporting tax deductions, such as for purchases of business or charitable items. Many business costs are initially born by employees. An employee may present a receipt to their employer for purposes of seeking reimbursement.

### SUMMARY

In accordance with an example embodiment of the subject application, a system and method for purchase cost allocation, payment and reporting includes a device receiving charge data corresponding to a purchase of goods or services from a merchant by a user. The device also receives a merchant category classification code associated with the merchant and stores account data corresponding to at least one business charge account and at least one personal charge account. A processor categorizes received charge data as a business charge or a personal charge in accordance with a comparison of received charge data and the merchant category classification code. The device generates debit data to at the business charge account or the personal charge account in accordance with categorized charge data.

In accordance with other example embodiments, charges are categorized in accordance with established company policies retrieved from a storage, from calendar data showing timing of business trips or from a location from where a purchasing transaction occurs.

### BRIEF DESCRIPTION OF THE DRAWINGS

Various embodiments will become better understood with regard to the following description, appended claims and accompanying drawings wherein:

FIG. 1 an example embodiment of a system 100 for personalized, policy based expense processing;

FIG. 2 is an example embodiment of a digital device;

FIG. 3 is a flowchart of an example embodiment of expense processing system;

FIG. 4 is a software module block diagram of an example embodiment; and

FIG. 5 is an example embodiment of a printout of data from an electronic receipt.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

As discussed above, employees may present receipts to their employer for reimbursement. In smaller or less formal businesses, reimbursement may be ad hoc. A business owner may subjectively determine whether the purchase was justified and whether the cost was reasonable under the circumstances. The owner may consider different factors relative to approving or disapproving the requested reimbursement. For example, an employee may frequently seek reimbursement for business lunches or dinners. The owner may determine a submission is justified, or unjustified, depending on the employee's job description, productivity or rate of reimbursement submissions.

Larger businesses may employ a more established reimbursement policy. For example, an employee may have an annual travel budget, or a monthly entertainment budget. A company may have pre-established, maximum rates or per diem amounts. They may have certain providers that are pre-approved or with whom special rates have been established. Requests may be processed, analyzed and approved or disapproved, in whole or in part, by an accounts payable person or department. Reimbursements can be further complicated when business purchases are coupled with personal or non-reimbursable expenditures. This may occur when an employee exceeds an allotted expense cap, placing the overage as the employee's personal responsibility. In other example situations, a family member may have accompanied an employee during a business meal, or a hotel receipt can include charges for personal items billed to a room account. If all charges are on a personal credit card, a portion will need to be reimbursed to the employee. If all charges are on a business credit card, an employee may have to reimburse the employer or have the amount deducted from a future pay.

In situations such as those exemplified above, considerable effort to isolate reimbursable expenses and amounts from non-reimbursable or personal expenses must be made. Complex situations may result in error and significant delay in processing of payments or reimbursements.

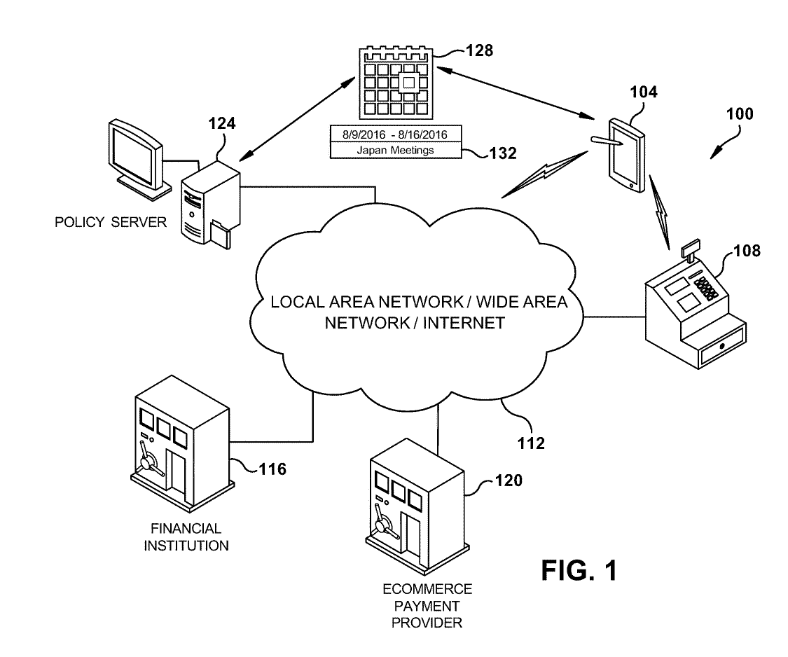

In accordance with the subject application, FIG. 1 illustrates an example embodiment of a system 100 for personalized, policy based expense processing. A user, such as an employee, has a personal digital device 104, such as a smartphone, tablet, notebook computer, or the like. Personal digital device 104 is provided with data input and data output capability via any suitable wired or wireless data communication system. Examples for wireless data communication include radio frequency based communication, such as WiFi, cellular, near field communication (NFC), or BLUETOOTH, as well as optical communication, such as via diode, including laser or infrared.

Personal digital device 104 is suitably enabled for data communication with one or more point-of-sale terminals, such as terminal 108. A point-of-sale terminal may be comprised of a check-out station at a retail establishment, such as a department store, gas station or hotel. A point-of-sale terminal is also suitably comprised of an online or telephonic sales system, such as a web-based or app-based ordering system. Terminal 108 communicates receipt information such as an itemized cost for purchases, item description or merchant description. By way of further examples, product descriptions may comprise stock keeping unit (SKU) data. SKU data is frequently preset for inventoried items and may include information could include information as to a manufacturer, product description, material, size, color, packaging, or warranty terms. Additional receipt information may include merchant category code (MCC) information. As currently implemented, A MCC is comprised of a four-digit number assigned to a business by credit card companies (for instance, American Express, MasterCard, VISA) when the business first starts accepting one of these cards as a form of payment. The code reflects the primary category in which the merchant does business and may be used by credit card companies to offer cash back rewards or reward points, for spending in specific categories. Additionally, the MCC is used to classify the business by the type of goods or services it provides. In the United States, it can also be used to determine whether or not a payment needs to be reported to the Internal Revenue Service for tax purposes.

Both personal digital device 104 and point-of-sale terminal 108 are also suitably connected to a data network 112, suitably comprised of a local area network, a wide area network, the Internet, or any combination thereof. Also in data communication with data network 112 are one or more financial institutions, such as illustrated by financial institutions 116 and 120. By way of example, financial instructions may be comprised of banks, credit agencies, lenders, credit unions, savings and loan institutions or the like. Financial institutions can also be suitably comprised of Internet or eCommerce payment services, such as PayPal, WePay, and the like. Financial institutions may accommodate employers, employees or both, presumably under separate accounts.

In accordance with a purchase, such as with personal digital device 104, information about the transaction is suitably communicated from terminal 108 to personal digital device 104 which, in turn, communicates some or all information for employer approval to a server, such as policy server 124. Policy server 124 suitably acts on product purchase information, suitably including pricing information, SKU data and/or MCC data, along with employee data setting forth the employees spending levels, permissions, budgets, history and the like. After applying policy data to the purchase information, policy server 124 communicates with personal digital device 104 providing data corresponding to allowable business expenditures. Personal digital device 104 suitably completes payment via terminal 108. Payment may be divided between a company account and the user's private account for charging as is appropriate for a particular transaction to one or more financial institutions. Alternatively, a single payment by the company or the user may be made with appropriate reimbursement made or scheduled. An electronic receipt corresponding to the purchase, suitably accompanied by data relative to payment breakdown, is retained by the digital device and/or sent to the employer, such as via policy server 124 or any suitable data gateway.

Computers, smart phones or tablets may be used to hold electronic calendars. A user may include a business itinerary. Business itineraries may include flight reservation information, including flight number, departure time/date and arrival time/date. Many times a user can have such information added into their calendar, such as an Outlook calendar or Google calendar by a website selection after booking. Personal calendar data may reside on any suitable computer. Electronic calendar 128 may be stored on personal digital device 104, policy server 124 or any other suitable data device. Information may be shared among multiple devices. By way of example, a user may enter calendar information 132 in personal digital device 104, and the calendar information 132 is shared with the policy server 124 when a data path is available. Similarly, a colleague, such as a secretary, can enter calendar information 132 and it will be replicated at the user's personal digital device 104. In addition to use of policy data as indicated above a determination may be made as to whether a charge is a business expense by comparing a time or date of charge with calendar information 132, for example a scheduled business trip. For example, certain expenditures may be considered business related that would not otherwise be considered so if policy data set accordingly. In the illustrated example, certain expenses, such as may be determined by cost, SKU or MCC information may be deemed business expenses if they occur in the Aug. 9, 2016-Aug. 16, 2016 date range.

Location information for personal digital device 104 may also be used in connection with determining business expenses. By way of example, if a user is determined to be outside of their home city, state or country, there may be additional information leading to a conclusion that expenditures are business related. With each purchase transaction, an electronic receipt is suitably generated by personal digital device 104, or alternatively by another networked device such as policy server 124, as will be described further, below.

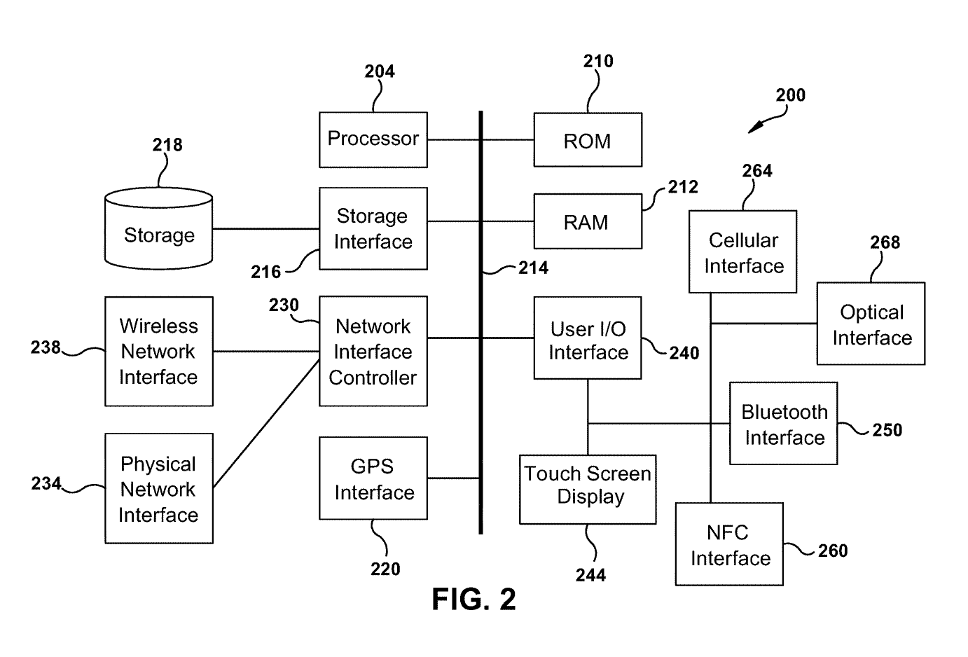

Turning now to FIG. 2, illustrated is an example embodiment of digital device 200 suitably comprised in personal digital device 104. Analogous architecture suitably comprise terminal 108 and policy server 124. Included are one or more processors, such as that illustrated by processor 204. Each processor is suitably associated with non-volatile memory, such as read only memory (ROM) 210 and random access memory (RAM) 212, via a data bus 214.

Processor 204 is also in data communication with a storage interface 216 for reading or writing to a data storage system 218, suitably comprised of a hard disk, optical disk, solid-state disk, or any other suitable data storage as will be appreciated by one of ordinary skill in the art. Positioning data for location based services is suitably obtained via a global positioning system (GPS) interface 220.

Processor 204 is also in data communication with a network interface controller (NIC) 230, which provides a data path to any suitable wired or physical network connection via physical network interface 234, or to any suitable wireless data connection via wireless network interface 238, such as one or more of the networks detailed above. The system suitably uses LBS or location based services, such as those described above, using GPS or wireless network information or combinations thereof.

Processor 204 is also in data communication with a user input/output (I/O) interface 240 which provides data communication with user peripherals, such as display 244, as well as keyboards, mice, track balls, touch screens, or the like. Also suitably included are a BLUETOOTH interface 250, a near field communication (NFC) interface 260, a cellular interface 264 and an optical, such as infrared, interface 268. It will be understood that functional units are suitably comprised of intelligent units, including any suitable hardware, or software platform.

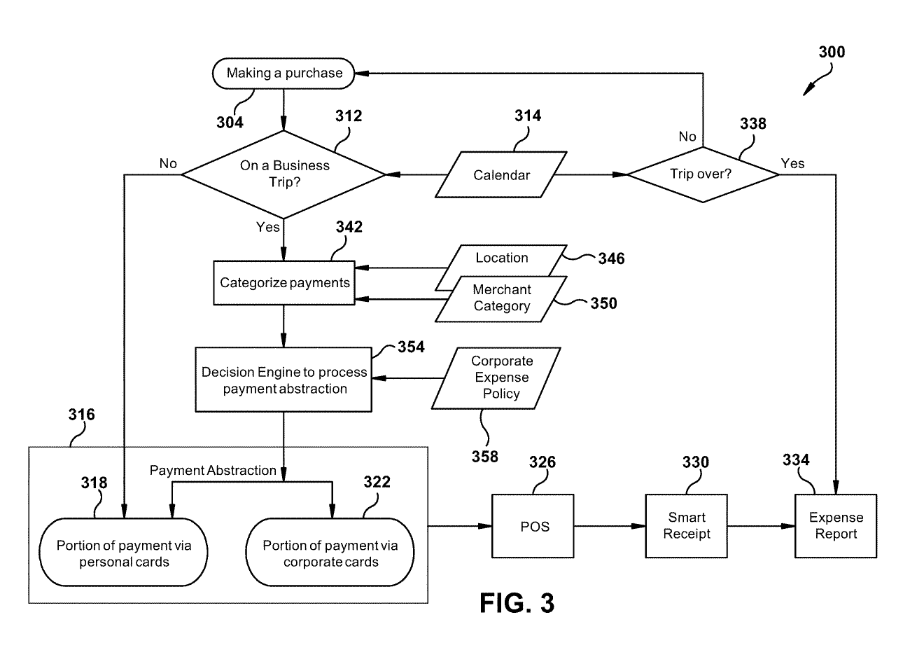

Referring next to FIG. 3, illustrated is a flowchart of an example embodiment of expense processing system 300. The process starts at block 304 when a purchase is made. A determination is made at block 312 as to whether the user making the purchase is on a business trip as determined by calendar information 314, such as may come from the user's digital device or a server. If not, progress is made to a payment abstraction system 316. Payment to the merchant is divided between personal payment method 318 and business payment method 322 in accordance with current breakdown of charges. Payment is accomplished with a vendor point of sale terminal at block 326, and a smart receipt generated at block 330. A complete expense report is generated or updated at block 334.

In addition to the forgoing, a business trip duration is monitored at block 338, suitably with calendar information 314. When the business trip is over, an expense report is generated at block 334.

A determination at block 312 that the user is on a business trip moves to block 342 wherein charges are categorized as business charges or personal charges in accordance with location information 346 and merchant data 350, such as merchant name, MCC data or SKU data. A payment abstraction decision is made at block 354 with corporate expense policy information 358, and the system progress to payment abstraction 314 as detailed above.

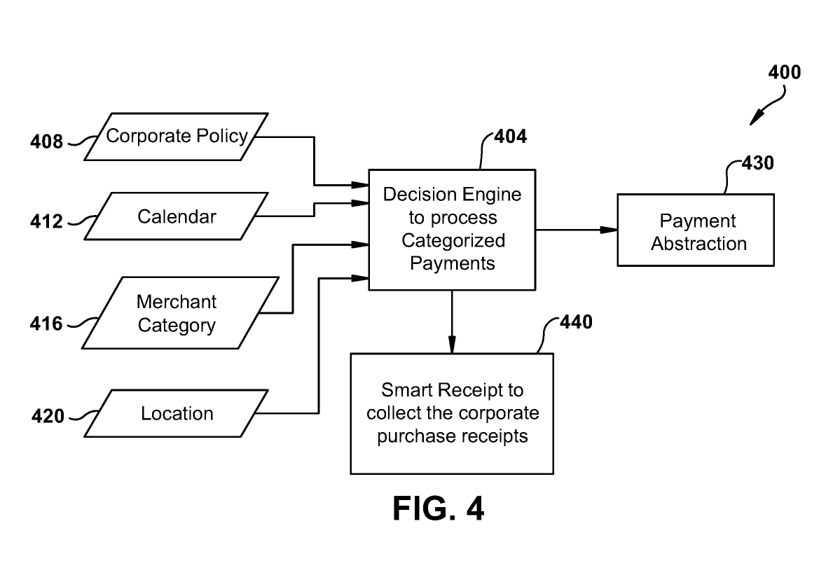

Turning now to FIG. 4, illustrated is a software module block diagram 400 of an example embodiment. Decision engine 404 processes and categorizes payments in accordance with corporate policy information 408, suitably from a company policy server, calendar information 412, such as from a user's Outlook or Google calendar information, merchant information 416, such as merchant name, MCC information or SKU information and location information 420. Payment abstraction engine 430 processes payments to the appropriate payment vehicle, such as a user's credit card or company credit card, as described above. Smart receipt generation engine 440 generates a smart receipt for use by the company as described above.

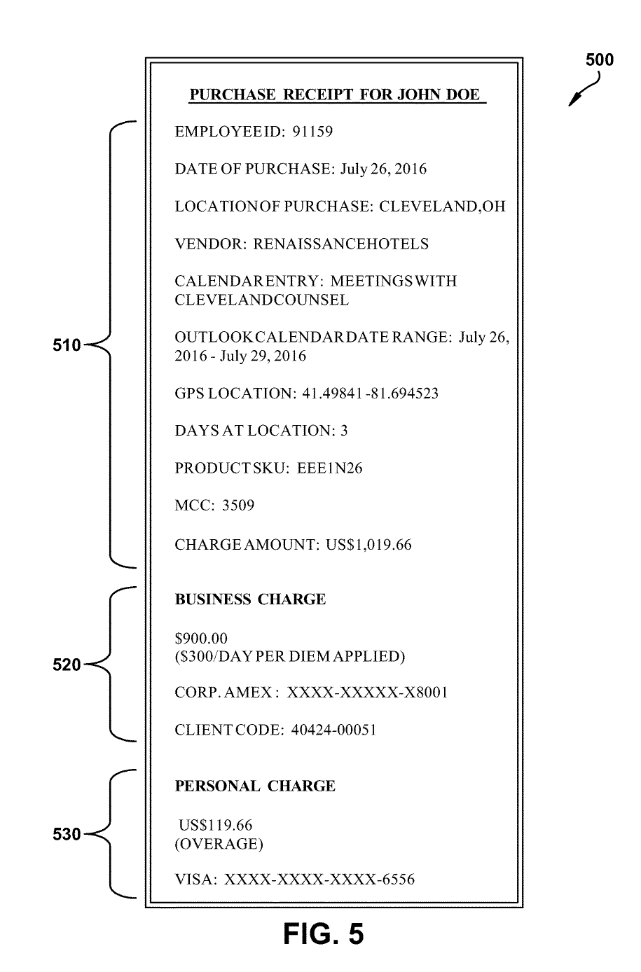

Referring now to FIG. 5, illustrated is an example embodiment of a printout of data from an electronic receipt 500 generated in accordance with the subject application. Data accumulated from location information, vendor information, product information, calendar information, and the like is listed at 510. Once payment abstraction has been completed, business charges are categorized at 520 while personal charges are categorized at 530.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
an input configured to
receive charge data corresponding to a purchase of goods or services from a merchant by a user, and
receive a merchant category classification code associated with the merchant;
a memory configured to store account data corresponding to at least one business charge account and at least one personal charge account;
a processor configured to categorize received charge data as a business charge or a personal charge in accordance with a comparison of received charge data and the merchant category classification code; and
an output configured to generate debit data to one or more business charge account or personal charge account in accordance with categorized charge data.

2. The system of claim 1 wherein the memory is further configured to store expense policy data corresponding to allowable business expenses for the user, and wherein the processor is further configured to generate the debit data in accordance with the expense policy data.

3. The system of claim 1 wherein the processor is further configured to generate receipt data in accordance with each debit of the business charge account specified by the debit data.

4. The system of claim 3 wherein the processor is further configured to generate an expense report corresponding to the receipt data for aggregate business charges after an end of a business trip as determined in accordance with the calendar data.

5. The system of claim 1 wherein the memory is further configured to store calendar data corresponding to an itinerary of the user, and wherein the processor is further configured to generate the debit data in accordance with the calendar data.

6. The system of claim 5, wherein the memory is further configured to store expense policy data corresponding to allowable business expenses for the user, and wherein the processor is further configured to generate the debit data in accordance with the expense policy data, and further comprising:
an output configured to communicate debit data corresponding to personal charges to the user's financial institution and debit data corresponding to business charges to a business financial institution.

7. The system of claim 6 wherein the processor is further configured to generate an expense report in accordance with debit data corresponding to allowable business expenses.

8. A method comprising:
receiving charge data corresponding to a purchase of goods or services from a merchant by a user;
receiving a merchant category classification code associated with the merchant;
storing account data corresponding to at least one business charge account and at least one personal charge account in a memory;
categorizing, via an associated processor, received charge data as a business charge or a personal charge in accordance with a comparison of received charge data and the merchant category classification code; and
generating debit data to one or more business charge account or personal charge account in accordance with categorized charge data.

9. The method of claim 8 further comprising:
storing, in the memory, expense policy data corresponding to allowable business expenses for the user; and
generating the debit data in accordance with the expense policy data.

10. The method of claim 8 further comprising generating receipt data in accordance with each debit of the business charge account specified by the debit data.

11. The method of claim 10 further comprising generating an expense report corresponding to the receipt data for aggregate business charges in after an end of a business trip as determined in accordance with the calendar data.

12. The method of claim 8 further comprising:
storing, in the memory, calendar data corresponding to an itinerary of the user; and
generating the debit data in accordance with the calendar data.

13. The method of claim 12 further comprising:
storing, in the memory, expense policy data corresponding to allowable business expenses for the user;
generating the debit data in accordance with the expense policy data; and
communicating debit data corresponding to personal charges to the user's financial institution and debit data corresponding to business charges to a business financial institution.

14. The method of claim 13 further comprising generating an expense report in accordance with debit data corresponding to allowable business expenses.

15. A mobile data device comprising:
a memory configured for storing calendar data corresponding to in itinerary of an associated user;
a wireless data interface configured for data exchange with an associated point-of-sale device,
the wireless data interface further configured for data exchange with an associated data network,
the wireless data interface further configured to receive corporate policy data corresponding to acceptable business charges, and
the wireless data interface further configured to receive charge data corresponding to a cost and a merchant category classification code in accordance with a purchase by the user of a good or service from a merchant; and
a processor configured to classify received charge data relative to personal charges and business charges in accordance with corporate policy data, calendar data, the merchant category classification code,
wherein the wireless data interface is further configured to communicate data corresponding to business charges to a business financial institution for payment, and
wherein the wireless data interface is further configured to communicate data corresponding to personal charges to a personal financial institution for payment.

16. The device of claim 15 wherein the processor is further configured to generate receipt data for each business charge after completion of a corresponding purchase.

17. The device of claim 16 wherein the processor is further configured to generate expense report data corresponding to an aggregation of business expenses after completion of a user business trip as specified by the calendar data.

18. The device of claim 16 wherein the wireless data interface is further configured to communicate the expense report to an associated server.

19. The device of claim 18 wherein the wireless data interface is further configured to communicate the receipt data to the associated server.

20. The device of claim 19 wherein the wireless data interface is comprised of a near field communication port for communication with the merchant and a cellular data interface for communication with the associated server.
